(19) United States
(12) Patent Application Publication
(10) Pub. No.: US 2012/0079559 A1
(43) Pub. Date: Mar. 29, 2012

(54) METHODS FOR POLICY MANAGEMENT

(75) Inventors: Alexander Reznik, Titusville, NJ (US); Oscar Lopez-Torres, King of Prussia, PA (US); Inhyok Cha, Yardley, PA (US); Lawrence Case, Austin, TX (US); Yogendra Shah, Exton, PA (US)

(73) Assignee: INTERDIGITAL PATENT HOLDINGS, INC., Wilmington, DE (US)

(21) Appl. No.: 13/078,716

(22) Filed: Apr. 1, 2011

Related U.S. Application Data
(60) Provisional application No. 61/320,665, filed on Apr. 2, 2010.
(60) Provisional application No. 61/320,910, filed on Apr. 5, 2010.
(60) Provisional application No. 61/362,597, filed on Jul. 8, 2010.

(51) Int. Cl. G06F 17/00

(52) U.S. Cl. 726/1

(57) ABSTRACT

Systems, methods, and apparatus are disclosed for coordinating enforcement of policies on a network and/or a wireless transmit/receive unit. The policies may include stakeholder-specific policies of one or more stakeholders that provide services on a user equipment. Enforcement of the stakeholder-specific policies may be securely coordinated using a policy coordination function. Systems, methods, and apparatus are also disclosed that include a network policy coordination function (NPCF) that coordinates service control policies and access control policies. The NPCF may coordinate enforcement of the service control policies for one or more service control entities and the access control policies for one or more access control entities.

### CROSS REFERENCE TO RELATED APPLICATIONS

This application claims the benefit of U.S. Provisional Application No. 61/320,665, filed Apr. 2, 2010, U.S. Provisional Application No. 61/320,910, filed Apr. 5, 2010, and U.S. Provisional Application No. 61/362,597, filed Jul. 8, 2010, the contents of which are incorporated by reference herein in their entireties.

### BACKGROUND

A wireless transmit/receive unit (WTRU) and/or a multi-connection network may be capable of performing functions and/or communications with and/or on behalf of one or more entities or stakeholders. For example, mobile devices may offer multi-connection services, such as constant connectivity to the Internet while continuing to offer good quality voice services. Such multi-connection services may be provided by or on behalf of different stakeholders, such as different network operators. Each stakeholder may desire such functions or communications to be performed in accordance with one or more policies of that stakeholder. The policies of the different stakeholders may be conflicting or complimentary.

### SUMMARY

Systems, methods, and apparatus are disclosed for management and/or coordination of enforcement of policies on a communications device and/or in communication networks. According to one embodiment, a user equipment is described that may provide services on behalf of one or more stakeholders. The user equipment may communicate with the one or more stakeholders and the stakeholders may govern the providing of services on the user equipment. The user equipment may include at least one processor, a memory, and a policy coordination function. One or more stakeholder-specific policies of the one or more stakeholders may be securely stored on the memory. Each stakeholder-specific policy may be a different stakeholder-specific policy and each stakeholder may be a different stakeholder. The policy coordination function may coordinate secure management and/or enforcement of the one or more stakeholder-specific policies of the one or more stakeholders, such as by executing within a secure environment on the processor.

According to another embodiment, a system is described that is configured to coordinate service control policies and access control policies for one or more networks having a plurality of access points. Each access point may be governed by one or more access control entities and each access control entity may be governed by one or more service control entities. The system may include a policy storage function and a network policy coordination function (NPCF). Service control policies and access control policies may be stored in the policy storage function. Enforcement of the service control policies and the access control policies may be coordinated by the NPCF. The NPCF may coordinate enforcement of the access control policies for the one or more access control entities. The NPCF may coordinate enforcement of the service control policies for the one or more service control entities.

Other features and aspects of the methods, systems, and apparatus described herein will become apparent from the following detailed description and the associated drawings.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is a diagram illustrating several aggregation scenario examples;

FIG. 3 is a diagram of a network architecture showing high-level nature of layer interaction;

FIG. 4 shows an example of policy coordination entities used for communications in a multi-connection network;

FIG. 5 is a diagram of a functional architecture showing network policy entities;

FIG. 6 shows another system diagram of an exemplary wireless communication system in which one or more of the disclosed embodiments may be implemented;

FIG. 7 is a functional block diagram of a wireless transmit/receive unit (WTRU) and a Node B of the wireless communication system of FIG. 6;

FIG. 8 shows a flow diagram for example security procedures in an IEEE 802.19 system;

FIG. 9 shows the chain of trust for initial access; and

FIG. 10 shows an example process for initial attachment and/or regular operations.

### DETAILED DESCRIPTION OF ILLUSTRATIVE EMBODIMENTS

When referred to hereafter, the terminology “wireless transmit/receive unit (WTRU)” may include, but is not limited to, a user equipment (UE), a mobile station, a fixed or mobile subscriber unit, a pager, a cellular telephone, a personal digital assistant (PDA), a computer, or any other type of device capable of operating in a wireless environment. When referred to hereafter, the terminology “base station” may include, but is not limited to, a Node-B, a site controller, an access point (AP), or any other type of interfacing device capable of operating in a wireless environment. When referred to hereafter, the terminology “NodeB” may include, but is not limited to, a Home NodeB (HNB), an e NodeB (eNB) or a Home eNodeB (HeNB). Also, any reference to the term “network” may refer to a radio network controller (RNC), controlling RNC (CRNC), drift RNC, or any other communication network as described herein for example.

Systems, methods, and apparatus are described herein for policy control management. Policy control management may be performed by a policy control entity that may be included in a WTRU and/or a network entity for example. The policy control entity may coordinate policies associated with one or more stakeholders associated with the WTRU and/or the network. According to one example, policy control may be performed for multi-connection communications in a multi radio access technology (RAT), such as in a next generation network (NGN) architecture for example.

According to one embodiment, a user equipment is described that may provide services on behalf of one or more stakeholders. The user equipment may communicate with the one or more stakeholders and the stakeholders may govern the providing of the services on the user equipment. The user equipment may include at least one processor, a memory, and/or a policy coordination function. One or more stakeholder-specific policies of the one or more stakeholders may be securely stored on the memory of the user equipment. Each stakeholder-specific policy may be a different stakeholder-specific policy and each stakeholder may be a different stakeholder. The policy coordination function may coordinate secure enforcement of the one or more stakeholder-specific policies of the one or more stakeholders, such as by executing within a secure environment on the processor.

According to another embodiment, a system is described that is configured to coordinate service control policies and access control policies for one or more networks having a plurality of access points. Each access point may be governed by one or more access control entities and each access control entity may be governed by one or more service control entities. The system may include a policy storage function and a network policy coordination function (NPCF). Service control policies and access control policies may be stored in the policy storage function. Enforcement of the service control policies and the access control policies may be coordinated by the NPCF. The NPCF may coordinate enforcement of the access control policies at one or more access control entities. The NPCF may coordinate enforcement of the service control policies at one or more service control entities.

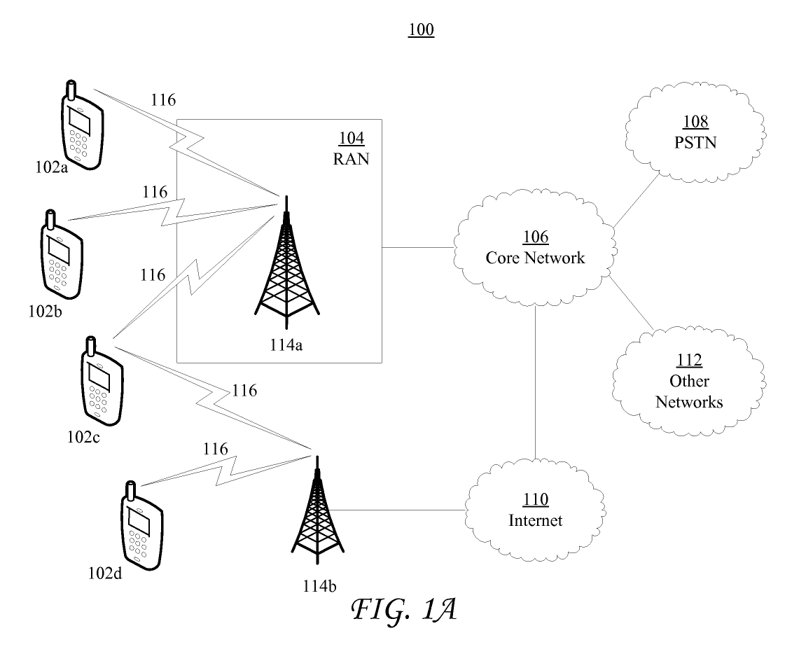

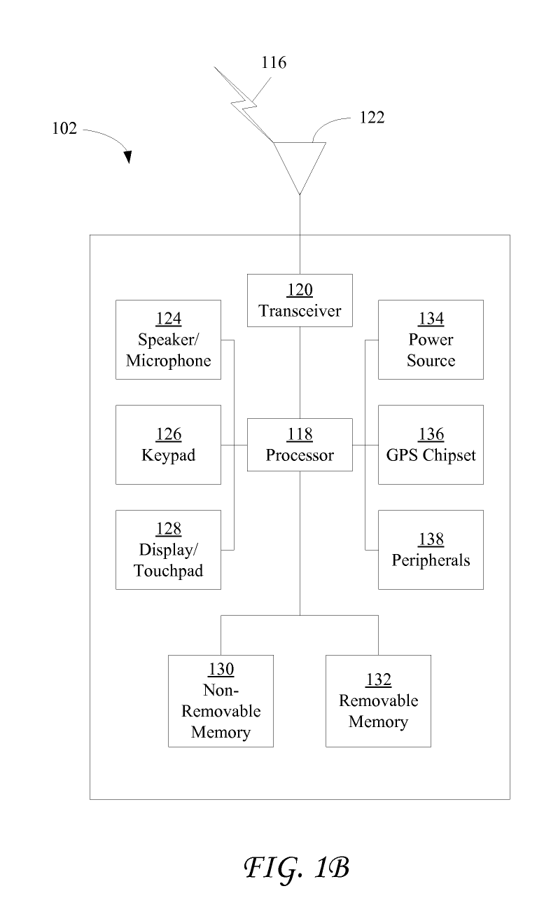

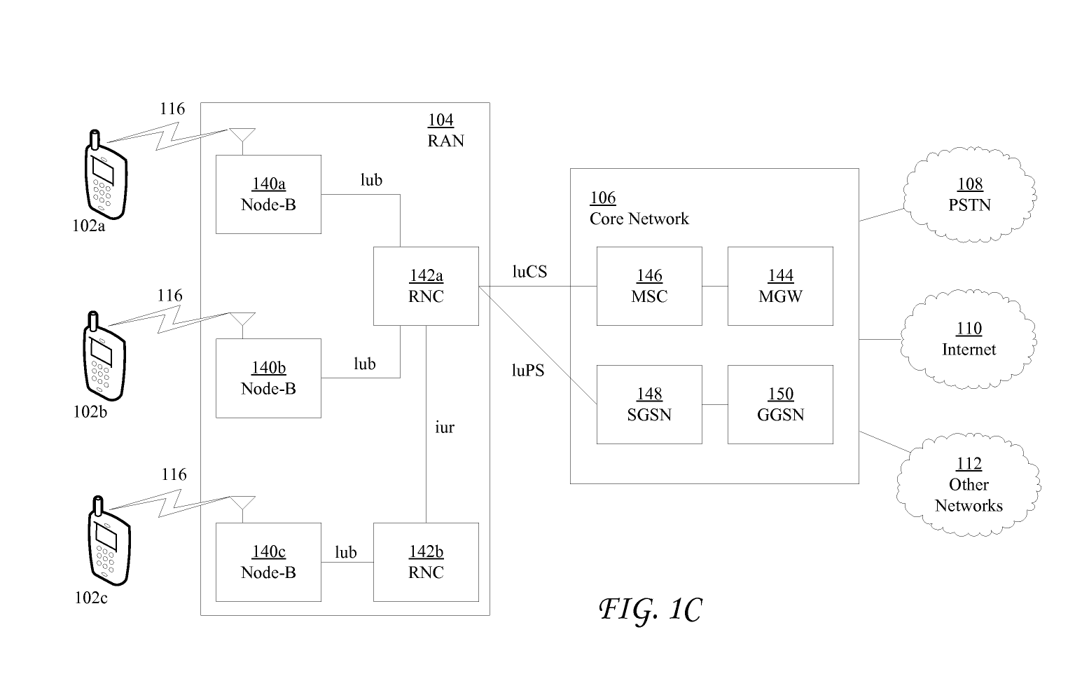

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

The communications systems described above, or portions thereof, may be used when performing policy management functions on a WTRU and/or network entity as described herein. In one example, the policy management functions may be performed for multi-connection operations on a WTRU and/or a multi-connection network.

As described herein, multi-connection operations may be available within one or more communications networks. For example, multi-connection operations across cellular and/or non-cellular radio access technologies (RATs) may be enabled within a mobile operator's communication networks. According to one example, the International Telecommunication Union Standardization Sector (ITU-T SG131Q9) on Next Generation Networks (NGN)/Future Networks is developing specifications (requirements, architecture, and/or technologies) for enabling multi-connection operation across cellular and/or non-cellular RATs within the scope of a mobile operator's communication networks. Multi-connection aggregation at various stages in the mobile network may also be performed.

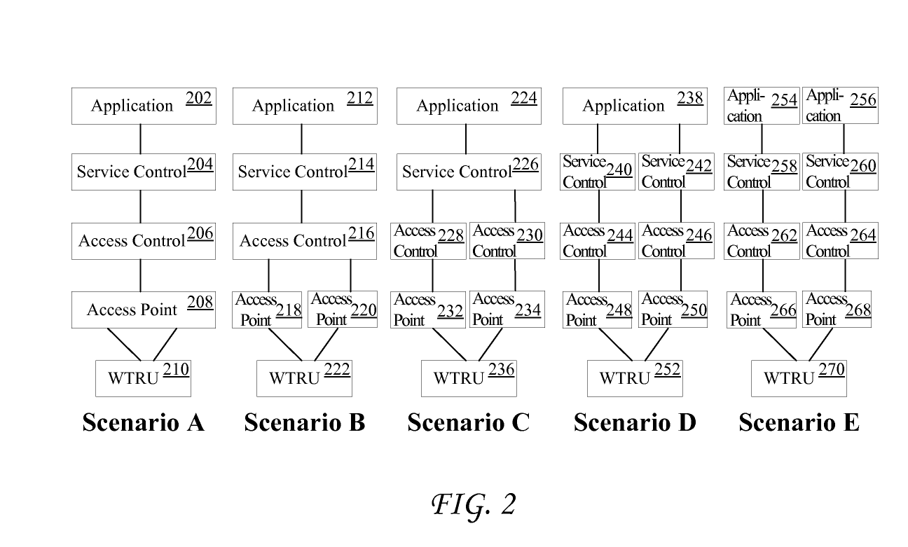

FIG. 2 is a diagram illustrating several aggregation scenarios on a mobile network. The diagram implicitly describes a high-level protocol architecture for the mobile network (e.g. it may illustrate a Next Generation Network implementation of an OSI 7-Layer protocol architecture and/or the Internet's 4-Layer TCP/IP architecture). For example, one or more of the scenarios illustrated in FIG. 2 may be implemented when performing policy management functions within and/or associated with one or more networks.

Referring to the scenarios shown in FIG. 2, Scenario E illustrates an operation of two distinct applications, Application 254 and Application 256, over two distinct radio access technologies (RATs), Access Control 262 and Access Control 264. A network operating under a scenario such as Scenario E may not perform an aggregation. For example, WTRU 270 may communicate over Access Control 262 and Access Control 264, via Access Point 266 and Access Point 268 respectively. Access Control 262 and Access Control 264 may communicate with Application 254 and Application 256, respectively, via Service Control 258 and Service Control 260.

Scenario D may relegate aggregation to Application 238, which may be outside the mobile network for example. Application 238 may have a certain amount of interaction with the network. For Example, WTRU 252 may communicate over Access Control 244 and Access Control 248, via Access Point 248 and Access Point 250 respectively. Access Control 244 and Access Control 246 may communicate with Application 238 via Service Control 240 and Service Control 242 respectively.

Scenario C illustrates one example for connection aggregation in the network. As illustrated in Scenario C, WTRU 236 may communicate over Access Control 228 and Access Control 230, via Access Point 232 and Access Point 234 respectively. Access Control 228 and Access Control 230 may communicate with Application 224, via Service Control 226. As shown in Scenario C, each connection may retain a dedicated access control mechanism and the aggregation may occur in Service Control 226. Because Service Control 226 may address service needs of Application 224, scenario C may roughly operate at the level of “service flows” (e.g. IP data flows). Scenario C may address heterogeneous underlying radio access technologies (RATs) that may preserve their own access control functions for example. Scenario C may allow Service Control 226 to aggregate these various technologies for at least the following functions: aggregation of the underlying access technologies and/or policy functions, such as quality of service (QoS) functions that they deliver to provide a better aggregate QoS for example, for the application and/or segregation of heterogeneous application data traffic into policy-specific sub-flows (e.g., QoS-specific sub-flows) which may then be matched to access technologies best suited to meet the requested policy (e.g., QoS) for each sub-flow. An example of this may be separation of hyper-text transfer protocol (HTTP) access into a data transfer sub-flow, video sub-flow and audio sub-flow, and/or mapping each sub-flow to an access means best suited to handle it.

Scenario B illustrates one example where a single access technology, such as Access Control 216, is used across multiple access points, as in e.g. a multi-antenna system such as coordinated multipoint transmission (CoMP). The definition of a single technology may be understood broadly here as “same family of technologies.” As illustrated in Scenario B, WTRU 222 may communicate over Access Control 216, via Access Point 218 and Access Point 220. Access Control 216 may communicate with Application 212 via Service Control 214. Scenario B may be applicable to operation of the same family of technologies across multiple spectra (e.g. cellular access technology in licensed cellular spectrum and its derivative aimed at a lightly licensed spectrum such as TV Band).

Scenario A illustrates one example where multi-access access points are operating within the network. For example, WTRU 210 may communicate with Access Control 206, via Access Point 208. Access Control 206 may communicate with Application 202, via Service Control 204.

According to one exemplary architecture, a single policy control entity may be located between a service control layer and an access control layer. However, this architecture may be deficient. Architecturally, a policy function may not be a layer which may sit between the service control and access control layers (e.g. no data or information may pass through the policies). A controller may tell the service control layer and/or the access control layer how to act on data. The nature of decisions made by service control (e.g. QoS matching) and access control (e.g. access technology mapping) may be different. Having a single joint decision making entity which simultaneously controls both may be unnecessarily complex and/or may be unnecessary in some systems, such as systems which support one multi-connection scenario for example. One approach which may support a dedicated policy service for the service control and access control, and/or provide loose coordination between them, may be implemented. Such an approach may simplify the design of policy definition, as well as testing of the resulting system. A set of policy rules, such as QoS rules, cost functions, and/or access rights for example, may define a number of potential policy engines which may act at the same time in a complimentary and/or in a contradictory manner.

These policy rules may not be tied to the protocol architecture and/or may be inappropriate in some cases. For example an aggregation policy designed to act on application policy may not be acting on the access control entities as the application policy rules may not be available. As it is an “aggregation policy,” such a policy may be appropriate in scenario C illustrated in FIG. 2, as this is where aggregation may be done by Service Control 226.

It is described herein how policy entities fit into this architecture. A set of policy rules may be defined and/or a set of rules may be tied to policies, such as QoS rules for example, when implementing a system that includes the policy entities described herein.

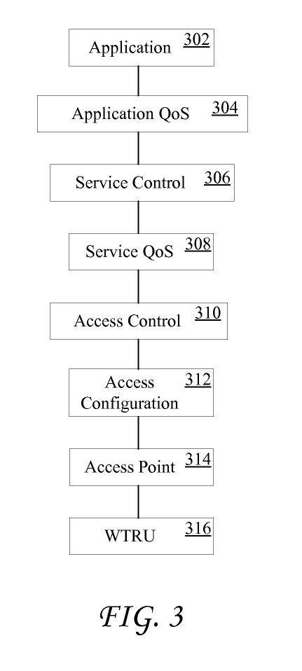

FIG. 3 shows several layers of the implied architecture of FIG. 2, and the high-level nature of layer interaction. For example, FIG. 3 shows the Application Layer 302, the Service Control Layer 306, the Access Control Layer 310, and the Access Point(s) Layer 314. The Application Layer 302 may be in communication with the Service Control Layer 306 and may reside inside and/or outside of the network. Application Layer 302 may communicate with Service Control Layer 306, via Application QoS 304 for example. Application Layer 302 may communicate with the network, using the network to transmit and/or receive data payload.

The Service Control Layer 306 may be in communication with the Application Layer 302 and/or the Access Control Layer 310. The Service Control Layer 306 may interact with the Application Layer 302, to understand its communication rules (e.g. QoS and/or other policy rules). The Service Control Layer 306 may interact with the Access Control 310 to ensure that the communication rules (e.g. QoS and/or other policy rules) are met.

The Access Control Layer 310 may be in communication with Access Point Layer 314 and/or Service Control Layer 306. The Access Control Layer 310 may be responsible for configuring and/or managing the various access methods (e.g. RATs) to ensure that policy rules (e.g., QoS and/or other policy rules) as requested by Service Control Layer 306 are met. The Access Control Layer 310 may communicate with Service Control Layer 306, via Service QoS 308 for example. The Access Control Layer 310 may communicate with Access Point Layer 314, via Access Configuration 312 for example.

The Access Point(s) Layer 314 may contain entities which may communicate with WTRU 316 and/or the Access Control Layer 310. The entities in Access Point Layer 314 may communicate with WTRU 316 over a physical medium (e.g. Base Stations, Wi-Fi APs, etc.). They may implement the RATs configuration rules made by the Access Control Layer 310.

As described above, a multi-connection network having multiple access points may be in communication with a device, such as a WTRU for example. In performing such communications between the multi-connection network and the device, one or more policies may be implemented at the device and/or the multi-connection network. When multiple policies are present, there may be conflicts between various policies on the device and/or on the network. For example, one or more different policies may correspond to different stakeholders. Stakeholders may include one or more networks and/or application service providers, manufacturers of a device, device users, and/or subscribers for example. A policy coordination entity may be implemented on a device and/or the network to resolve such conflicts.

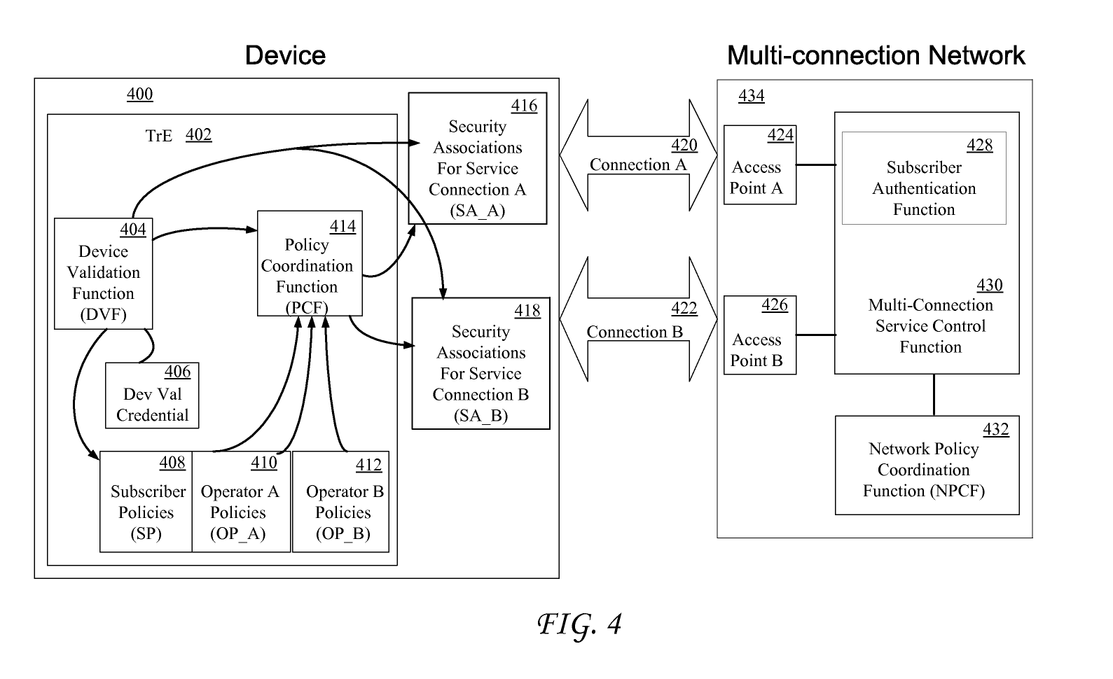

FIG. 4 shows an exemplary system that includes entities that may be used in coordinating policies that may be relevant for network communications in a multi-connection network. For example, FIG. 4 illustrates a device policy coordination function (PCF) 414 for use in coordinating multiple policies on a device 400. PCF 414 may be included in device 400. Device 400 may be a communication device in communication with a network, such as multi-connection network 434 for example. FIG. 4 also illustrates a network policy coordination function (NPCF) 432 for use in coordinating multiple policies on a device 400 and/or a multi-connection network 434. NPCF 432 may be included in the multi-connection network 434 for example.

With regard to the PCF 414, device 400 includes the PCF 414 for coordinating relevant policies when performing communications. The PCF 414 may perform functions to coordinate policies of different stakeholders of the device 400. For example, each stakeholder may be associated with a different application, smartcard, and/or UICC installed on and/or associated with the device 400. The policies may be coordinated on behalf of one or more stakeholders. The PCF 414 may span many functions for efficient operation of device 400. One or more parameters may be included in the PCF 414 for use in policy coordination, such as security policy handling, communication QoS handling, handling of multiple communications links, or other policy parameters for example.

The device 400 may provide for a trusted and secure execution environment for securely performing policy installation, configuration, update, coordination, or the like. For example, device 400 may include a Trusted Environment (TrE) 402. The TrE 402 may refer to a logical entity that provides a trustworthy environment for the execution of sensitive functions and the storage of sensitive data. Data produced through execution of functions within the TrE 402 may be unknowable to unauthorized external entities. For example, the TrE 402 may be configured to prevent unauthorized disclosure of data to external entities. The TrE 402 may perform sensitive functions (such as storing secret keys, providing cryptographic calculations using those secret keys, and executing security policies) that may be used to perform a device integrity check and/or device validation for example. The TrE 402 may be anchored to an immutable hardware root of trust that may not be tampered with. For example, the TrE 402 may be a slave to device 400. For example, the TrE 402 may include a SIM card, such as may be used in GSM devices for example. The implementation of the TrE 402 may depend on the application and/or on the required level of security for example.

The TrE 402 may be a secure environment in which the PCF 414 may be executed. The PCF 414 of the device 400 may execute policies from different stakeholders. The PCF 414 may also resolve conflicts among policies from multiple stakeholders. PCF 414 components may reside in firmware, hardware, and/or software. Authorization to modify high level PCF 414 functions may belong to a root authority. Delegation of this authority may be achieved through a chain of trust assured by the Trusted Environment (TrE) 402. Prioritization in specific PCF 414 resolution functions may be assigned to stakeholders in a mutually exclusive and/or mutually privileged manner (e.g. equal but different) so that each non-root stakeholder may have priority over some results but not over others.

The PCF 414 may initiate procedures and/or may respond to dynamic conditions. The PCF 414 may receive status and/or measurements in real-time so that a change in an input may result in a change in action or set of actions. Such change in actions or set of actions may take place immediately upon the change in input, or with a controlled time delay for example.

The PCF 414 may act as a proxy to the NPCF 432. For example, the PCF 414 on the device 400 may implement policies which are “peers” to those implemented by the NPCF 432. These peer policies may be sub-policies that are generated from the master policies implemented by the NPCF 432. The NPCF 432 may handle computationally intensive operations and/or may have administrative privileges to optimize the PCF 414 functions of the device 400. The NPCF 432 may provide services on behalf of one of the stakeholders and/or have control over some aspect of the PCF 414. In some cases, the PCF 414 may be better suited, due to its location in the network for example, to detect changing conditions and/or enforce network-wide policies accordingly. The NPCF 432 may act autonomously based on inputs it receives, or it may act semi-autonomously between some instructions and/or decisions on the network side and some locally made decisions. Alternatively, the NPCF 432 may act on instructions and/or decisions solely from the network.

In security policy handling, the PCF 414 may suggest instructions for how to proceed in the case of a device integrity validation failure. Examples of policy based enforcement may include, but are not limited to, mechanisms including binding device validation to pre-shared-secret-based client authentication, binding device validation to certificate-based device authentication, and/or binding device integrity validation to other device functions. Security policies may indicate one or more security parameters. For example, security policies may indicate algorithm suites to be used, a strength (e.g. lengths) of the keys to be used, security protocols to be used, a security protocol to be used, retention policies (e.g. duration, entities that verify validity of a key and/or a lifetime of a key, exception clauses), deprecation, deletion, and/or update of cryptographic keys. The security policies may be indicated for stakeholders, and/or services or applications intended for the stakeholders, for example. Different security policies may be indicated for different stakeholders, and/or different services or applications intended for the different stakeholders. According to one example, where the QoS is defined from the perspective of the strength of the security provided for each communication of the multiple connections, security-specific QoS policies may be applied.

The PCF 414 may consider the rules set forth by multiple stakeholders for utilizing services. For example, the PCF 414 may resolve conflicts between stakeholder policies with its coordination capability. A subscriber may have a subscriber policy (SP) 408 with an enforcement rule. For example, the SP 408 may request a minimum security strength (e.g. cryptographic strength) for business phone calls and a preference for the cheapest phone service available. The PCF 414 may initiate the device to negotiate the security associations on the cheapest service, such as Security Associations for Service Connection A (SA_A) 416 for example. Device 400 may attempt to establish connection with Network 434 at Access Point A 424, via Connection A 420 for example. If the connection may not be achieved at the level of security requested by the SP 408, then this information may be fed back to the PCF 414. The PCF 414 may incorporate the status and/or initiate a second secured call using another operator at a higher cost, such as Security Associations for Service Connection B (SA_B) 418 for example. Device 400 may then establish a connection with multi-connection network 434 at Access Point B 426, via Connection B 422 for example. As illustrated, Connection B 422 may be established between device 400 and multi-connection network 434 at the level of security requested by the SP 408.

Access Point A 424 and Access Point B 426 may be in communication with multi-connection service control function 430. Multi-connection service control function 430 may include subscriber authentication function 428 for authenticating subscriber information. The NPCF 432 may coordinate policies associated with the multi-connection service control function 430.

According to another example, a subscriber may wish to transfer data files from an enterprise network to a wireless device. The subscriber may request multi-connection communication, using multiple services simultaneously to achieve a transmission rate. The PCF 414 may enforce usage of comparable security key strengths to maintain a minimum security level for data transferred among the multiple connections according to the various stakeholder (e.g. enterprise) policies. In this case, if the transmission rate is not achieved as advertised despite the multiple channels, the subscriber may want to have a record of this, perhaps signed by the PCF 414, by a trusted entity within the TrE 402, and/or the TrE 402 itself. In another example, the subscriber may deny that the fast rate was achieved and the service providers may want a copy of this, that may be signed by the PCF 414, or other possible signing entities for example. The PCF 414 may thus have a signing capability to prevent repudiation of services. In the event of a PCF 414 integrity check failure the TrE 402 may prevent access to the PCF 414 signing key. Alternatively, another trusted entity within the TrE 402 may sign the data produced by the PCF 414. In a PCF 414 integrity check failure the TrE 402 may prevent access to the signing key held by that other trusted entity that would sign the data produced by the PCF 414.

The PCF 414 may also coordinate policies related to key generation, derivation, and/or bootstrapping for different stakeholders of the device. For example, referring to FIG. 4, a high-level key may be generated by a shared secret between a subscriber stakeholder and a primary operator A. Depending on the SP 408, Operator A Policies (OP_A) 410, and/or Operator B Policies (OP_B) 412, further child-level shared keys that may be used between the device 400 and the operator B may be derived out of keys generated between the subscriber and Operator A. A bootstrap mechanism may be used to generate these keys.

According to another embodiment, the PCF 414 of the device 400 may be implemented not within the integrated TrE 402 of the device 400, but within an entity or module that is plugged or connected to the device 400. The entity or module may be attachable and/or detachable from device 400. An example of such an entity may be an advanced version smart card or a UICC.

Integrity of certain components in the device 400 may be protected by the Device Validation Function (DVF) 404. The DVF 404 may be included inside the TrE 402 and/or may perform device integrity-checking to verify whether the integrity of the components of the device 400 are preserved or not. For example, the DVF 404 may check the integrity of the components of device 400. The DVF 404 may perform device integrity checking using Device Validation Credentials 406 for example. The integrity information may be used for device validation by the network and/or the device itself. For example, once the integrity of the components of the device 400 have been checked, the DVF 404 may sign the integrity data and/or any additional related supplementary data using a Private Key of the TrE 402 before forwarding the integrity data on to other entities for validation purposes.

The DVF 404 may provide assurance that the stakeholders with appropriate authority may modify the PCF 414 function under control of that authority. The assurance provided by the DVF 404 may include the Device Validation Credential 406. High level PCF 414 functions may reside under an administrative PCF authority. The administrative PCF authority may be a subscriber, operator, application service provider, and/or device manufacturer for example. The administrative PCF may be configured by the manufacturer or may be configured later, such as in the case of an operator, application service provider, or subscriber for example. The TrE 402 may protect against unauthorized update and/or modification to the PCF 414 functions and/or protect the stakeholder policies on the device including isolation of the policy functions from each other for example.

The TrE 402 may protect policies on the device using the DVF 404. For example, the TrE 402 may use the DVF 404 to perform ‘gating’ procedures, that may gate access to one or more applications, functions, and/or data held in the TrE 402, such as the Device Validation Credential 406 for example. The gating procedures may depend on the status of device integrity validation results. The gating procedures may ‘cascade.’ For example, the DVF 404 may gate access to one function or application, while that function or application may gate access to another function, application, or data for example. The DVF 404 may gate multiple procedures or data, some or all of which may have causal or corresponding relationships.

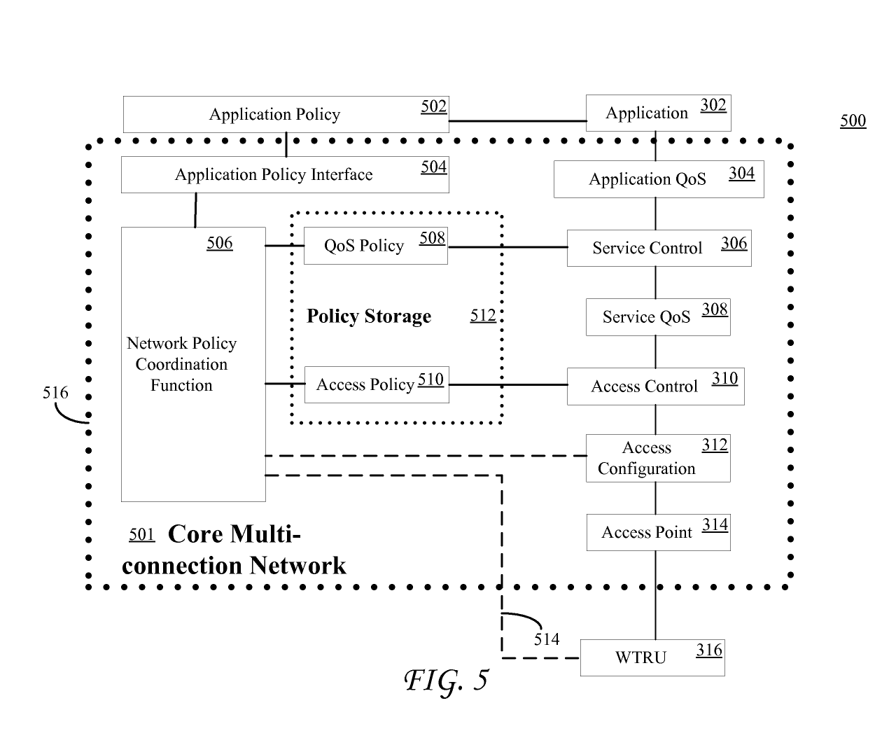

FIG. 5 shows policy coordination functions that may be performed by the NPCF. FIG. 5 illustrates a system/protocol architecture showing the policy entities that are present. The functional architecture shown in FIG. 5 delineates the boundary of a core network to illustrate the various roles played by the network entities. In any given system, some, or all, of the illustrated entities may be present. For example, the existence of one or more illustrated entities may depend on which of the scenarios described in FIG. 2 are enabled.

The Network Policy Coordination Function (NPCF) 506 may be a functional entity in the Core Multi-connection Network 501. The NPCF 506 may have a multi-connection control function. NPCF 506 may receive connection information from a multi-connection registration entity, and/or request operator policy from an operator policy storage entity on a per WTRU-basis. As shown in FIG. 5, the NPCF 506 may communicate with the Application Policy Entity 502, which may be a multi-connection application policy entity for example. The Application Policy Entity 502 may be included in and/or associated with the Application Layer 302, via the Application Policy Interface 504. When there is IP flow for the WTRU 316, the NPCF 506 may execute the policy to route the IP flow to the most appropriate network among the multi-connections.

The NPCF 506 may coordinate the operation of various policy entities in the Core Multi-connection Network 501. When multiple policies are present, NPCF 506 may resolve conflicts between various policies. The applicability of the NPCF 506 may be on large time periods, i.e., preventing the use of certain policies at the same time, while the more at-the-moment policy execution may be left to individual policy entities.

The NPCF 506 may implement a service transfer policy function. The NPCF 506 may include the functionality to be executed jointly over one or more layers. Thus, the NPCF 506 may include a Multi-Connection Registration Function and/or a Multi-Connection Control Function, as illustrated in FIG. 2 for example.

The NPCF 506 may interface with the WTRU 316. This interface is shown by the dotted line 514 between the NPCF 506 and the WTRU 316 in FIG. 5. The WTRU 316 may implement policies which are “peers” to those in the network. For example, these peer policies may be sub-policies that are generated from the master policies in the quality of service (QoS) Policy Entity 508, the Access Policy Entity 510, and/or within the NPCF 506 itself. The peer policies may include QoS functions, cost functions, access rights to data, or other policy functions for example. The sub-policies may be communicated to the WTRU 316 which may then follow the sub-policies. A master policy may contain multiple WTRU 316 sub-policies that may be changed based on the behavior of the WTRU 316, Core Multi-connection Network 501 conditions, and/or radio interface conditions.

The functional architecture of FIG. 5 may recognize that of the architecture in scenario D illustrated in FIG. 2. The Application 302 may make multi-connection decisions and may possess the Application Policy Entity 502. The Application Layer 302 and Application Policy Entity 502 may be external to the Core Multi-connection Network 501, as shown with the dashed line 516. The Core Multi-connection Network 501 may possess an interface to the Application Policy Entity 502. Accordingly, the Application Policy Interface 504 may provide an interface between the NPCF 506 in the Core Multi-connection Network 501 and the Application Policy Entity 502—divided between the Core Multi-connection Network 501 and the Application Layer 302.

The Application Policy Interface 504 may provide a means for the Application Policy Entity 502 and the Core Multi-connection Network 501 to exchange information about the nature of the policies being used for aggregation and/or avoid policy conflicts. For example, if the Application 302 has applied a policy which may request certain data sub-flows to be placed on specific connections, the NPCF 506 may communicate this policy via the Application Policy Interface 504 to ensure that another multi-connection operation, such as the acquisition of another access point for example, does not move the data to a different connection.

The QoS Policy Entity 508 and/or the Access Policy Entity 510 may be embedded in the Policy Storage Function 512, as shown in FIG. 5. The Policy Storage Function 512 may perform more than a storage function. The Policy Storage Function 512 may execute policy decision and/or comparison among a number of policies, such as QoS policies for example, to avoid conflict among them.

The Service Control Layer 306 may meet the policy needs of the Application 302 by matching them to the available access policies. For example such policies may include QoS policies. A QoS Policy Entity 508 may be included at the Service Control Layer 306. For example, in scenario C illustrated in FIG. 2, the multi connection decisions may be made by the Service Control Layer 306, which may be influenced by the application's QoS needs. The QoS Policy Entity 508 is exemplary and may be representative of any policy entity that may be used by Service Control Layer 306.

The QoS Policy Entity 508, as illustrated in FIG. 5, may implement the QoS policies. Additionally, the QoS Policy Entity 508 may perform service transfer policies, where the multi-connection scenario C, as illustrated in FIG. 2, encompasses the use cases for initial and/or final target mix of the multi connections for the service transfer. The access changes and/or updates may involve multi-connections between access control entities and service control entities.

In scenario B, as illustrated in FIG. 2, the multi connections may be managed by the Multi-connection Access Control Function 216, which may manage connections across a set of access points, such as Access Point 218 and Access Point 220, that may utilize a homogeneous set of access technologies. Access Policy Entity 510, as illustrated in FIG. 5, may provide for usage of various access points.

The Access Policy Entity 510 may implement access network selection policy. Access Policy Entity 510 may perform service transfer policies, where the multi-connection scenario B, as illustrated in FIG. 2, may encompass the use cases for the initial and final target mix of the multi-connections for the service transfer. The access changes may involve multi-connections between access point entities and access control entities.

Described below are several types of policy requests. The five models illustrated in FIG. 2, scenarios A, B, C, D, and E, may entail different policy functionalities according to the involved radio access technologies, access control, service control, and/or application needs.

On a scenario-wise approach, different policy requests are described below.

For example, networks supporting scenario B, as illustrated in FIG. 2, may include an Access Policy Entity 510, illustrated in FIG. 5. The Access Policy Entity 510 may support policies for meeting policy requests (e.g. QoS requests) by the access technology through aggregation of the multiple available access points for example. Access policies may control how access methods are configured. For example, in a cellular network, access policies may include QoS class and in a Wi-Fi network the access policies may include a traffic priority. The access policies may also include a spectrum to be used, an access point to be used, the number of channels to be aggregated, and/or whether peer-to-peer connectivity may be used (e.g. accessing the Internet by tethering to another device via Bluetooth technology).

According to another example, networks supporting scenario C, as illustrated in FIG. 2, may include a QoS Policy Entity 508, illustrated in FIG. 5. As illustrated in FIG. 5, the QoS Policy Entity 508 may support policies for meeting application QoS by appropriately using the QoS offered by the various available access technologies for example. QoS policies may address high level issues. For example, QoS policies may indicate one or more access networks to be used, how a connection may be set up (e.g. what protocol and/or streaming method may be used), and/or a priority of a connection. QoS policies may also indicate an importance of latency, throughput, fidelity, cost, or the like, from a QoS perspective for example.

According to another example, networks supporting scenario D, illustrated in FIG. 2, may include an Application Policy Interface 504, illustrated in FIG. 5. As illustrated in FIG. 5, the Application Policy Interface 504 may provide an interface to the Application Policy Entity 502, which may be a multi-connection policy entity for example. The Application Policy Interface 504 may provide details to the Application Layer 302 to make the same, or similar, QoS-level decisions in a configuration such as scenario D, as are made on the network in scenario C for example.

Some policies may be common to one or more of the 5 scenarios illustrated in FIG. 2. For example, networks may be able to communicate policies to the WTRU 316 via the Service Control Layer 306. Multi-connection networks, such as the Core Multi-connection Network 501 for example, may include an NPCF 506 for coordination of the multiple policy entities present in the network.

While the PCF and the NPCF may be described herein, and illustrated in FIGS. 4 and 5 for example, as two independent entities, policy coordination may be performed on the device PCF, the NPCF, or shared by the device PCF and the NPCF. Thus, any functionality described herein as being performed by the device PCF may be performed by the NPCF, any functionality described herein as being performed by the NPCF may be performed by the device PCF, and/or any policy coordination functionality described herein may be performed jointly by the device PCF and the NPCF.

Based on description above, a set of policy management requests, such as QoS management requests for example, is described below.

In a multi-connection network, the WTRU and the network may be aware of the interactions created by the number of simultaneous accesses provided to the application and/or associated QoSes. The combination or resulting QoS may portrait the combined QoSes involved in a specific service.

The descriptions provided below include some of the multi-connection QoS requests.

For example, in Scenarios A, B, and C, as illustrated in FIG. 2, the Service Control Layer may provide to the application a resulting QoS that is at least as good as the QoS provided by an individual access technology by itself.

According to another example, in Scenarios A, and B, as illustrated in FIG. 2, the Access Control Layer may deliver access technology QoS to Service Control that is at least as good as QoS provided by any individual access link by itself

According to another example, in Scenario A, as illustrated in FIG. 2, the Access Point 208 may deliver QoS to the Access Control 206 that is at least as good as the QoS of any individual access link under its control.

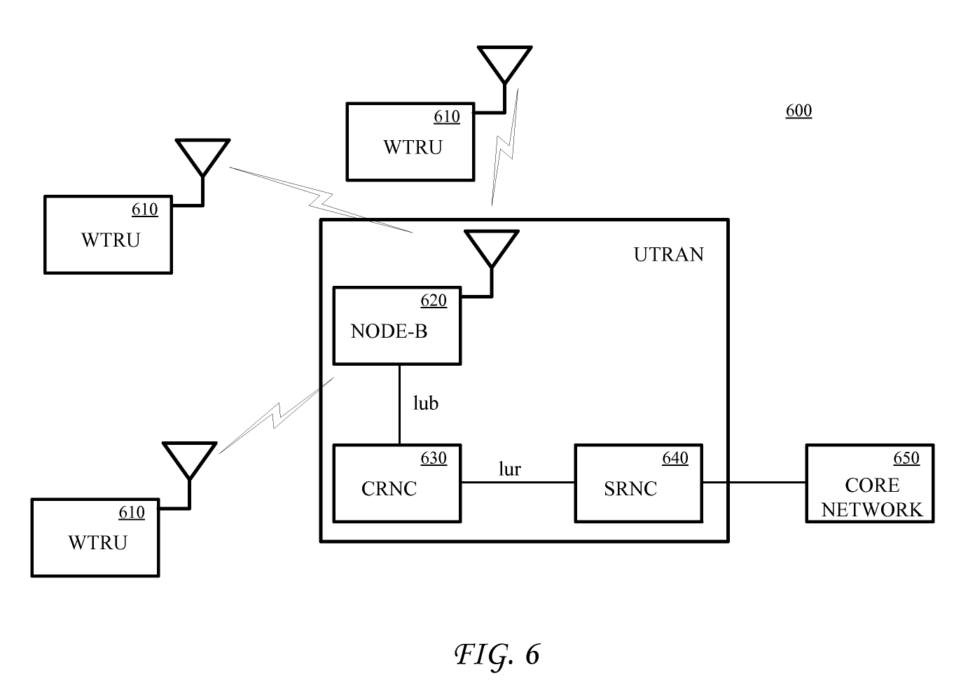

FIG. 6 shows an exemplary wireless communication system 600 that may be implemented in performing policy coordination, as described herein. Wireless communication system 600 may include a plurality of WTRUs 610, a Node-B 620, a controlling radio network controller (CRNC) 630, a serving radio network controller (SRNC) 640, and a core network 650. The Node-B 620 and the CRNC 630 may collectively be referred to as the UTRAN.

As shown in FIG. 6, the WTRUs 610 are in communication with the Node-B 620, which is in communication with the CRNC 630 and the SRNC 640. Although three WTRUs 610, one Node-B 620, one CRNC 630, and one SRNC 640 are shown in FIG. 6, any combination of wireless and/or wired devices may be included in the wireless communication system 600.

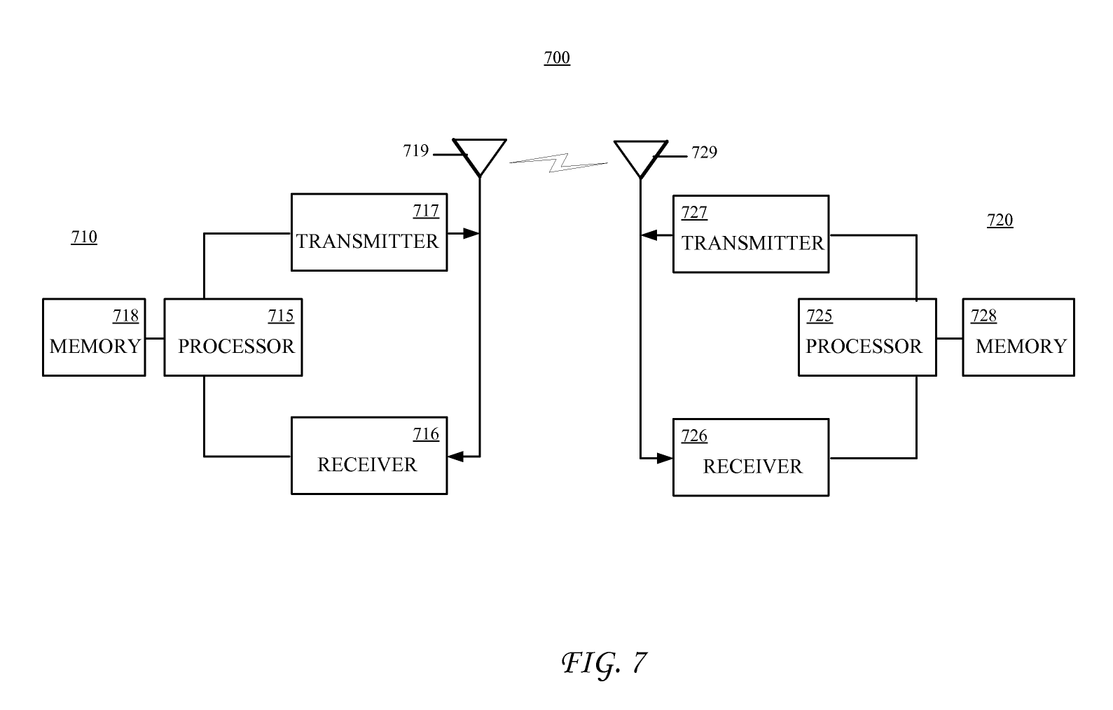

FIG. 7 is a functional block diagram 700 of a WTRU 710 and a Node-B 720 of the wireless communication system 600 of FIG. 6. As shown in FIG. 7, the WTRU 710 is in communication with the Node-B 720 and both are configured to perform a method for QoS and policy management for multi-connection communications, such as in a multi-RAT NGN architecture for example.

In addition to the components that may be found in a WTRU, the WTRU 710 includes a processor 715, a receiver 716, a transmitter 717, a memory 718, and an antenna 719. The memory 718 may store software including an operating system, applications, etc. The processor 715 may perform, alone or in association with the software, a method for QoS and/or policy management for multi-connection communications, such as in a multi-RAT NGN architecture for example. The receiver 716 and the transmitter 717 are in communication with the processor 715. The antenna 719 is in communication with both the receiver 716 and the transmitter 717 to facilitate the transmission and reception of wireless data.

In addition to the components that may be found in a Node-B, the Node-B 720 includes a processor 725, a receiver 726, a transmitter 727, a memory 728, and an antenna 729. The processor 725 is configured to perform a method for QoS and/or policy management for multi-connection communications, such as in a multi-RAT NGN architecture for example. The receiver 726 and the transmitter 727 are in communication with the processor 725. The antenna 729 is in communication with both the receiver 726 and the transmitter 727 to facilitate the transmission and/or reception of wireless data.

Suitable processors may include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

According to one embodiment, the systems, methods, and apparatus described herein for policy coordination may be implemented in a system using TV White Space (TVWS). For example, systems, methods and apparatus are described for coordination and/or execution of security procedures in a system supporting coexistence among independently operated TV band device (TVBD) networks and dissimilar TV band devices. For example, the IEEE 802.19 standard specifies radio technology independent methods for coexistence among dissimilar or independently operated TVBD networks and dissimilar TVBDs. A new entrant to the system may discover an 802.19 system and/or send a request to join. Access negotiation may then be performed along with authentication procedures. The system may provide a system policy, which may be committed. The new entrant may commit to at least a part of the system policy, which may be supplied in a list for example. The system policy may be updated. The new entrant may de-commit at least a part of the system policy or the updated system policy. For the authentication procedure, the new entrant may perform a local integrity check of a trust state using a TrE to produce an attestation or measurements of platform integrity, and send the measurement or attestation data for verification of the trust.

According to one example, radio technology independent methods may be specified for coexistence among dissimilar or independently operated TVBD networks and dissimilar TVBDs. For example, the IEEE 802.19 standard, or other similar standards, may specify such radio technology independent methods. The 802.19 standard may enable the family of IEEE 802 wireless standards to effectively use TV White Space (TVWS) by providing standard coexistence methods among dissimilar or independently operated TVBD networks and dissimilar TVBDs. The 802.19 standard may address coexistence for IEEE 802 networks and devices and may also be useful for non-IEEE 802 networks and TVBDs.

The core network 106, as illustrated in FIGS. 1A and 1C, may include network entities supporting IEEE 802.19 including, but not limited to, a coexistence discovery and information server (CDIS), a coexistence manager, TVWS database, and the like. The CDIS is an entity that may collect information related to TVWS coexistence and may provide coexistence related information and support discovery of coexistence managers. The coexistence manager may be an entity that makes a coexistence decision and/or generates and provides coexistence requests and commands and control information. The TVWS DB may provide a list of channels occupied by primary users.

Embodiments for security procedures (e.g., in an IEEE 802.19 system) are disclosed hereafter. In accordance with one embodiment, a WTRU and/or network (e.g. TV band device and/or TV band device network) and the 802.19 system may perform discovery, access control, policy negotiation, and/or policy enforcement procedures. The procedures performed during operation may include policy updates and/or changes and other coexistence mechanisms, (e.g., channel selection, power control, time-divisions, or the like). The embodiments described herein may use an IEEE 802.19 system for example, but the embodiments may be applied to any other systems for supporting coexistence among dissimilar or independently operated TV band device (TVBD) networks and dissimilar TVBDs.

An 802.19 system is a club that not everyone has to join or not everyone may be allowed to join (although many may be invited). Club rules may be many, but may be optional. There may be entities around who are not members of the club. To join the club, a new entrant may perform discovery and/or access control procedures. The new entrant may get the list of rules (coexistence policy) and/or declare which one(s) it is going to follow (i.e., negotiation of coexistence policies). The new entrant may follow the policies to which it commits.

The new entrant may have freedom to declare what policies it is and is not willing to follow. This may determine how the new entrant will be treated, (e.g., the more flexible it is willing to be the more others will work with it). Once a policy commitment is made, the new entrant may remain honest to that policy commitment. Club rules may change. The set of policies that are being employed may depend on what networks/devices are active. Thus, entry and exit of networks and devices may affect the policy set. The networks and devices may be nomadic. Moving from club-to-club may be fairly easy, but connection continuity may not be maintained, (i.e., no handover).

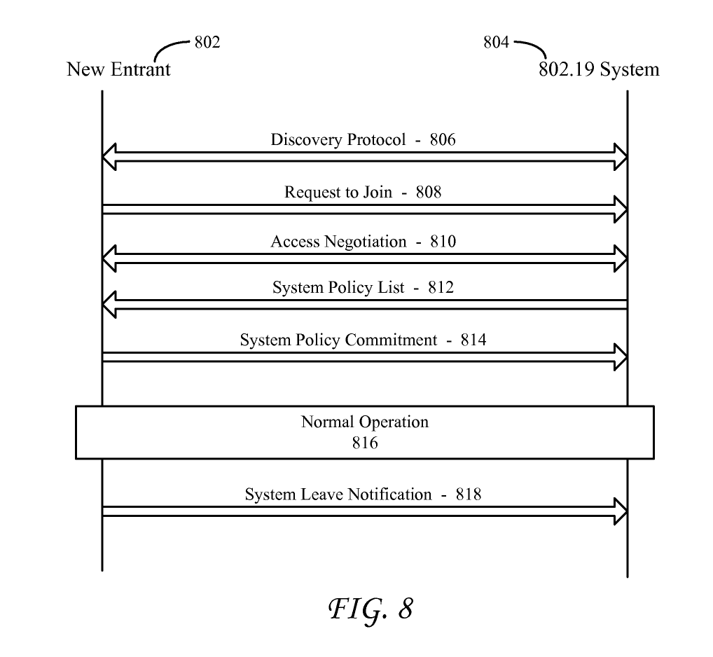

FIG. 8 shows a flow diagram of example security procedures in the IEEE 802.19 system. The new entrant 802 and the 802.19 system 804 perform a discovery protocol 806. The new entrant accesses the 802.19 system 804 by sending a request to join 808 to the 802.19 system 804. The 802.19 system 804 comprises other 802.19 capable network devices that have decided to cooperate for coexistence. Authentication and/or access negotiation 810 may be performed between the new entrant 802 and the 802.19 system 804.

The 802.19 system 804 provides a system policy (coexistence policy) list to the new entrant and the new entrant performs policy commitment 814 or de-commitment (i.e., negotiate coexistence policies). Not all network devices may, or are willing to, do all things. A “proof” that policies may be followed may be sent to the 802.19 system 804. After the system policy commitment 814, normal operation 816 may be performed between the new entrant 802 and the 802.19 system 804. The new entrant 802 may request “coexistence help” or may receive and execute coexistence requests. The new entrant 802 may leave the system by sending a system leave notification 818 to the 802.19 system 804. All exchanges between the new entrant 802 and the 802.19 system 804 may use standard integrity and confidentiality protection and may leverage mechanisms provided by the transport means used.

For the authentication procedures that are performed during the access negotiation 810, centralized architectures or distributed architectures may be implemented. In the centralized architecture, standard approaches, (e.g., 802.1X), may be used for authentication for example. A coexistence discovery and information server (CDIS) may be the entity providing an authentication server.

In the distributed architecture, the fact that every “master” device may authenticate itself to the TVWS database (DB) may be used. The TVBD or TVBD network may manage unlicensed operation in the broadcast TV spectrum at locations where that spectrum is not being used by the licensed services. The TVWS DB may provide the list of channels occupied by primary users. The TVWS DB may be used to provide proof of successful authentication of the new entrant to the TVWS DB. This scheme may be used for the centralized architectures as well, which may avoid having an authentication server in the CDIS. TrEs may be used when performing the authentication procedures described herein.

The TrEs may provide measurements of the trustworthiness of the functionality in the new entrant to behave in an expected manner. The TrEs may perform an internal self check of the trust state of the new entrant, (i.e., hardware, software, and data self-check based upon the integrity measurements of the software components in the new entrant). A signed token from the TrE of the outcome of the (local) integrity checks may be included in a message from the new entrant to the 802.19 system. The 802.19 system may validate the token based upon the identity of the TrE in the token (and the new entrant) and referring to a trusted third party (TTP) verifier. The TTP verifier may provide security architecture, profile, and/or capabilities information about the new entrant based upon its identity.

The integrity of the TrE in the new entrant may be checked by the hardware anchored Root of Trust (RoT). The RoT and the TrE may be trusted via its public key and traceability to the TTP for its security architecture, profile, and/or capabilities information. The TrE may be loaded and executed in the new entrant. The TrE may prepare a list of the loading order of the modules and/or groups of components of the new entrant to verify and load. The TrE may create and/or sign a token to distribute to the 802.19 system to attest to its trustworthy state. The token may be signed by the private key of the TrE. The trust nature of the TrE in the device and the token may be verified by reference to the TTP. The 802.19 system may decide on access authorization based upon the integrity verification information, validate the new entrant, and/or sign the token with its own credentials. The 802.19 system may forward the token to the new entrant after performing mutual authentication. The TrE in the new entrant, after authentication, may be free to distribute the 802.19 system signed token to other 802.19 system entities to assure them of its trustworthy state.

Included in the challenges in the trust-based authentication in a distributed setting may be that there is no centralized server for authentication and the manner in which the 802.19 system may know the identity of the new entrant. The challenges may be addressed by using the available resources assuming existence of a trust system and secure authentication and/or registration with a Regulatory TVWS Database.

The trust-based authentication procedures in a distributed setting are disclosed herein. The new entrant may perform internal self-check and/or produces measurements or attestation of platform integrity. The new entrant may access the TVWS DB. This access may be secure. The new entrant may use a secure, trusted process to produce a token of successful registration with the Regulatory Database using a specific database ID. For example, a token may be a certificate such as an electronic or lightweight certificate. The token may be transported and/or traced back to a trusted third party for example.

The new entrant may perform the 802.19 authentication procedure. The new entrant may request access and/or participation in the 802.19 system. The new entrant may produce a verifiable token of its platform integrity. The new entrant may identify itself to the 802.19 system using the same ID used to register with regulatory DB and signed with a token of success DB registration.

The 802.19 system may assess trust in the new entrant as follows: The system may verify the new entrant's platform integrity. The platform integrity may ensure that new entrant regulator DB ID is honestly produced. Database ID may be associated with a public key infrastructure (PM) key pair to allow signing of the token with the private key of the TrE. Platform integrity may ensure that the token of successful DB registration is honestly produced. If all of these pass, the 802.19 system may trust that the new entrant did indeed successfully register with a (known) regulatory DB and may use that fact as a basis of trust and authentication. This process may not require the regulatory DB to provide any services other than those it is required to provide.

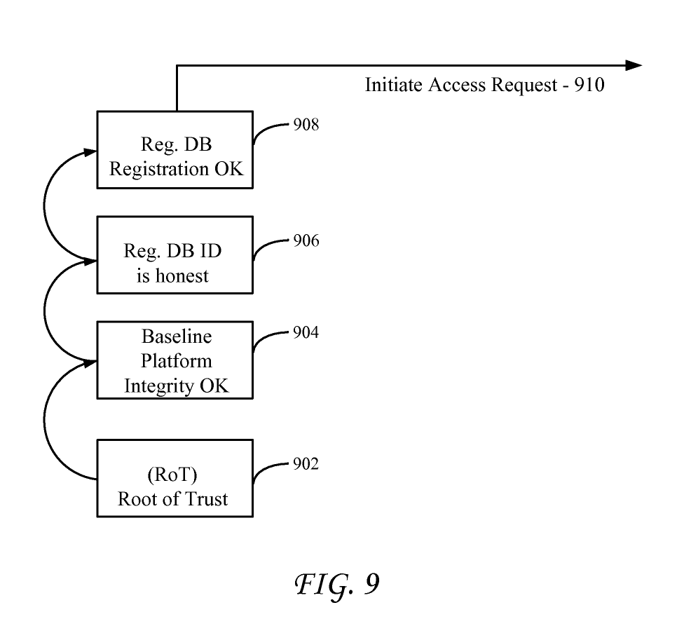

FIG. 9 shows the chain of trust for initial access. As illustrated in FIG. 9, an 802.19 system may check the Root of Trust (RoT) 902. The 802.19 system may then check the baseline platform integrity 904 of a new entrant. This may incorporate the policies and/or the 802.19 functionality for example. The 802.19 system may then check that the registered database identification is honest at 906. This may be performed to authenticate the new entrant for example. The 802.19 system may check the registered database identification in a database stored on the 802.19 system. If the registered database identification is ok, at 908, the new entrant may be registered with the 802.19 system. The 802.19 system may generate a token for the new entrant to use to communicate in the 802.19 system. The new entrant may initiate access request at 910. For example, the new entrant may roam the 802.19 system and/or use the generated token to communicate with other 802.19 devices. In one embodiment, the 802.19 devices rely on the token generated by the 802.19 system for authenticity, and my not authenticate the new entrant independently.

Device tampering may occur (i.e., if the device commits to policy, but does not intend to implement it or if the device commits to policy and tries to implement it but cannot because it was tampered with). Threats of device tampering may be addressed using security mechanisms, such as a TrE for example.

Information may be provided that indicates that the device has not been tampered with. It may be done once, as part of the access and/or registration procedure. A token may be generated that may be circulated to other 802.19 entities. A TrE-based attestation of honesty may be used with each policy commitment (and/or de-commitment). The TrE-based attestation of honesty may intermittently and/or infrequent use TrE functionality. With proof of platform integrity (token generation and/or passing) this may prove that policies that were committed to may be followed.

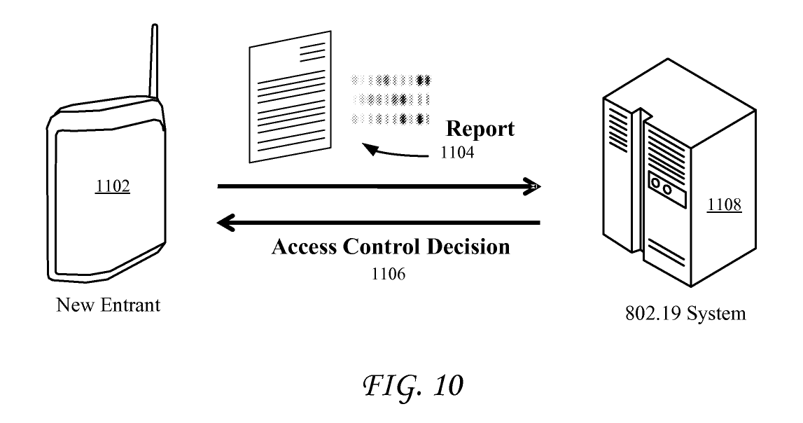

FIG. 10 shows an example process for initial attachment. As illustrated in FIG. 10, a new entrant 1102 may perform a secure start-up by measuring and/or checking integrity of system components. The new entrant may send a report 104 to the 802.19 system 1108 (generate token) relating to self-check measurements or data and security profile/capabilities information. The 802.19 system 1108 may analyze the information in the report to assess trustworthiness. The 802.19 system 1108 may respond by allowing access, or may disallow access if the device is deemed untrustworthy based upon the information supplied in the report. The access information may be sent to the new entrant 1102 via the access control decision 1106.

The new entrant 1102 may roam into the region of a TVBD network and may perform policy negotiation. The new entrant 1102 may broadcast policy commitments. The new entrant 1102 may execute coexistence mechanisms.

Upon policy change, policy negotiation, and/or authentication, the new entrant 1102 may send a report to the 802.19 system 1108 relating to self-check (token) and/or security profile information, and may monitor policy update messages and/or perform policy re-negotiation and/or broadcast updated policy commitments. The new entrant 1102 may execute coexistence mechanisms.

As described herein, the 802.19 system may send a system policy update to the new entrant, and the new entrant may respond with the system policy commitment. Each network and/or device may be free to choose which policies it may or is willing to follow. Once the network and/or device declares which policies it may or is willing to follow, the network and/or device commits to following them. After policy commitment, a coexistence mechanism may be executed. The new entrant may declare a policy de-commitment.

Although the systems, methods, and apparatus described herein may be described within the context of 3GPP UMTS wireless communications systems, they may be applied to any wireless technology. For example, the embodiments described herein may be applied to a wireless technology where control channel monitoring set is used (e.g. LTE, LTE-A, and/or WiMax). For example the solutions may be extended to LTE for the PDCCH monitoring set.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A user equipment that may provide services on behalf of one or more stakeholders, and wherein the providing of the services may be governed by the one or more stakeholders, and wherein the user equipment communicates with the one or more stakeholders, the user equipment comprising:
at least one processor;
a memory in which one or more stakeholder-specific policies of the one or more stakeholders are securely stored, wherein each stakeholder-specific policy is a different stakeholder-specific policy, and wherein each stakeholder is a different stakeholder; and
a policy coordination function (PCF), configured to execute on the processor, that coordinates secure enforcement of the one or more stakeholder-specific policies of the one or more stakeholders.

2. The user equipment of claim 1, where the PCF is configured to execute within a secure environment within the user equipment.

3. The user equipment of claim 2, wherein the secure environment is a trusted environment (TrE) or a smartcard.

4. The user equipment of claim 2, wherein the processor is further configured to perform a gating procedure in the secure environment to gate access to an application, function, or data stored in the secure environment.

5. The user equipment of claim 2, wherein the secure environment protects against unauthorized updates to the one or more stakeholder-specific policies.

6. The user equipment of claim 1, wherein the one or more stakeholder-specific policies may include at least one of a security policy, a communication quality of service policy, a policy associated with multiple communications links, or a cost function.

7. The user equipment of claim 1, wherein the PCF is a proxy to a network policy coordination function (NPCF) that resides on a network.

8. The user equipment of claim 1, wherein the PCF considers each stakeholder-specific policy for utilizing the services.

9. The user equipment of claim 1, wherein the PCF coordinates secure enforcement of the one or more stakeholder-specific policies of the one or more stakeholders based on a subscriber policy.

10. The user equipment of claim 9, wherein the subscriber policy is related to a security strength associated with network communications.

11. The user equipment of claim 9, wherein the subscriber policy is related to a subscriber preference associated with a cost of an available service on a network.

12. The user equipment of claim 1, wherein the one or more stakeholder-specific policies are configured to be modified by a root authority, wherein the root authority is a stakeholder of the one or more stakeholders.

13. The user equipment of claim 12, wherein the root authority has an authority to modify the PCF.

14. The user equipment of claim 1, wherein the PCF is under control of an administrative PCF authority.

15. The user equipment of claim 14, wherein the administrative PCF authority is at least one of a subscriber, an operator, or a device manufacturer.

16. The user equipment of claim 1, wherein the one or more stakeholder-specific policies are received from an external source.

17. The user equipment of claim 1, wherein the external source is a network entity.

18. The user equipment of claim 1, wherein each of the one or more stakeholder-specific policies is related to a different service provided by a respective stakeholder of the one or more stakeholders.

19. A system configured to coordinate service control policies and access control policies, wherein each access point of a plurality of access points are governed by one or more access control entities, and wherein each access control entity is governed by one or more service control entities, the system comprising:
a policy storage function in which the service control policies and the access control policies are stored; and
a network policy coordination function (NPCF) configured to coordinate enforcement of the service control policies and the access control policies, wherein the NPCF is configured to coordinate enforcement of the service control policies for the one or more service control entities, and wherein and the NPCF is configured to coordinate enforcement of the access control policies for the one or more access control entities.

20. The system of claim 19, wherein the service control policies and the access control policies are main policies that are representative of sub-policies that are configured to be implemented on a wireless transmit/receive unit.

21. The system of claim 19, wherein the NPCF is configured to coordinate enforcement of the service control policies and the access control policies on a TV band device system.
